(19) United States
(12) Patent Application Publication
(10) Pub. No.: US 2007/0036290 A1
(43) Pub. Date: Feb. 15, 2007

(54) Voicemail system and related method

(75) Inventors: Massimiliano Gasparri, Los Angeles, CA (US); Lewis Ostrover, Los Angeles, CA (US); Spencer Stephens, Toluca Lake, CA (US); Chris Odgers, Claremont, CA (US)

Correspondence Address: CONNOLLY BOVE LODGE & HUTZ LLP, P.O. BOX 2207, WILMINGTON, DE, 19899, US

(73) Assignee: Warner Bros. Entertainment Inc.

(21) Appl. No.: 11/366,198

(22) Filed: Mar. 1, 2006

Related U.S. Application Data
(60) Provisional application No. 60/657,763, filed on Mar. 2, 2005.

(51) Int. Cl. H04M 1/64

(52) U.S. Cl. 379/88.12

(57) ABSTRACT

A voicemail system, a computer-readable medium, and a related method for analyzing an audio signal from a caller that is stored as a voicemail message for a recipient. The method includes providing the audio signal, analyzing the audio signal, and detecting a defect in the audio signal.

### CROSS-REFERENCE TO RELATED APPLICATION

Priority is claimed under 35 U.S.C. § 119(e) to the U.S. Provisional Patent Application No. 60/657,763, filed on Mar. 2, 2005, entitled “Voicemail System and Related Method,” by Massimiliano Gasparri, Lewis Ostrover, Spencer Stephens, and Chris Odgers, which application is incorporated by reference herein.

### BACKGROUND OF THE INVENTION

1. Field of the Invention

The invention relates generally to the field of telephone messaging systems or other relevantly similar systems. More specifically, the invention relates to voicemail systems that detect noise dropouts or relevantly similar disruptions or distortions occurring in voicemail messages.

2. Description of the Related Art

Voicemail systems allow telephone callers to direct an audio message to a recipient or recipients. The recorded audio message can be distorted due to defects that are introduced either in the audio message itself, or during transmission of the audio message. There are several sources of defects in audio messages, for example, when a speech signal is recorded, additive noise often is recorded. In noisy environments, e.g., automobiles, the noise level can exceed the speech level, and thus, the signal-to-noise ratio can drop below the level where it is possible to discriminate between speech and ambient sound. In these instances, the intelligibility of the speech included in the audio message is reduced, and the quality of the recorded speech is poor. Listening to these noisy recordings is difficult and annoying for the recipient. Defects also can be introduced into the audio during its transmission, e.g., dropouts or other distortions in transmission that can occur with wireless communication, which degrade the transmitted audio quality.

A number of different approaches, e.g., the use of enhancement techniques, transmission techniques, and post-transmission filtering, have been taken to improve the intelligibility of noisy speech signals. Enhancement techniques process the speech signal before it is transmitted to the recipient, in an effort to make the speech signal less susceptible to noise during transmission. An example of an enhancement technique is a noise-canceling microphone.

In another approach, transmission techniques are used that minimize contamination of the speech signal during transmission to the recipient. Examples of transmission techniques include the use of transport-layer error correction mechanisms such as automatic request for retransmission (“ARQ”) and forward error correction (“FEC”). In ARQ, the receiver utilizes a return channel to send requests for the retransmission of lost packets to the sender. Thus, this mechanism requires two-way communication so that a return channel can be established between the receiver and the sender. ARQ works well for point-to-point protocols, for example, Transmission Control Protocol/Internet Protocol (“TCP/IP”), which is a suite of communications protocols used to connect hosts on the Internet that utilizes ARQ.

FEC is a method of communicating data where the speech signal is processed through an algorithm that adds extra bits to the digitized speech signal. The extra bits are added for error correction purposes. If the transmitted speech signal is received in error, the extra bits are used to check and repair the signal. FEC codes are a valuable basic component of any transport protocol that provides for the reliable delivery of content. FEC provides the ability to overcome both erasures (losses) and bit-level corruption.

In another approach, post-transmission filtering is performed on the transmitted speech signal, which reduces the effects of noise on the transmitted speech signal. The use of filters to suppress undesired aspects of an audio signal, and to enhance desired aspects of an audio signal, is well known. For example, record labels have long used filters when restoring older analog recordings for reissue in digital format. Different types of filters, e.g., high-pass, low-pass, and bandpass filters, can be used to suppress/enhance frequencies of the audio signal.

Also, a parametric equalizer can be used to filter out any fixed-frequency noise included in the audio signal. Parametric equalizers provide tone controls that enhance or reduce specific frequency ranges. Parametric equalizers even can eliminate simple, fixed-frequency noise components, and more complex audio signals, like ground hum, which include harmonics, i.e., multiples of 60 Hz.

In addition, many software packages exist that remove impulse noise, which includes short-duration artifacts like clicks, scratches, and crackling, in an audio signal. Virtually all audio restoration programs provide declicking tools with presets for different types of impulse noise.

However, none of the present noise-removal techniques provide for the detection of dropouts as well as noise in the audio signal of a voicemail message. Accordingly, there is a need for a system and related method that provides for the detection of dropouts in a voicemail message. The present invention satisfies this need, as well as other needs as discussed below.

### SUMMARY OF THE INVENTION

The invention resides in a voicemail system, a computer-readable medium, and a related method that solve a problem associated with voicemail messaging systems, that being unintelligible, noisy and/or incompletely recorded voicemail messages. An exemplary embodiment of the present invention is a voicemail system that includes a caller node and a recipient node. The caller node is configured to facilitate telephonic communication by a caller and to generate an audio signal based on input from the caller. The recipient node is coupled to the caller node and configured to do the following: facilitate telephonic communication by a recipient, receive the audio signal from the caller node, and record the audio signal as a voicemail message. The recipient node includes a computer-readable medium having a recipient node program, which includes instructions that are configured to analyze the audio signal and to detect a defect in the audio signal.

In other, more detailed features of the invention, the defect is a dropout, a distortion, and/or noise. Also, the caller node or the recipient node can be a phone, a computer, and/or a voicemail server. In addition, the instructions of the recipient node program can detect a defect in the audio signal and inform the caller and/or the recipient of the defect in the audio signal if the audio signal fails to meet a predetermined minimum quality level based on an analysis performed by the instructions of the recipient node program. The recipient node can inform the caller and/or the recipient of the defect in the audio signal by sending the caller and/or the recipient an electronic-mail message, calling the caller and/or the recipient using synthesized speech, and/or calling the caller and/or recipient using a prerecorded message.

In other, more detailed features of the invention, the instructions of the recipient node program are configured to filter out noise in the audio signal, enhance the audio signal, and/or restore the audio signal. Also, the instructions of the recipient node program can detect a defect in the audio signal and inform the caller and/or the recipient of one or more of the following: steps being taken to correct the defect in the audio signal, a confidence level associated with a restoration process of the audio signal, and whether the audio signal is recoverable. In addition, the instructions of the recipient node can be configured to determine if information is missing from the voicemail message as a result of the defect, and to restore the missing information to the voicemail message.

In other, more detailed features of the invention, the recipient node includes a voice transcription technology that is configured to convert the audio signal into a text transcript. The instructions of the recipient node program are configured to perform a linguistic analysis on the text transcript and to create a corrected message by inserting the missing information into the voicemail message based on the results of the linguistic analysis. The corrected message can be a text message, a voicemail message that includes the original audio signal and an additional audio signal that was created based on the results of the linguistic analysis, or a voicemail message that includes a single audio signal created entirely from the results of the linguistic analysis. The voicemail system can further include a network that is coupled between the caller node and the recipient node.

In other, more detailed features of the invention, the voicemail system further includes a voice channel that is coupled between the caller node and the recipient node. The voice channel is configured to establish a voice connection between the caller node and the recipient node, and to permit the transfer of the audio signal from the caller node to the recipient node. The voicemail system can further include a data channel that is coupled between the caller node and the recipient node. The data channel is configured to establish a data connection between the caller node and the recipient node. The caller node is configured to record the audio signal as a voicemail message. The audio signal is recorded as a voicemail message in the recipient node and the caller node while the voice connection is open. The data connection between the recipient node and the caller node is maintained after the voice connection is closed. The instructions of the recipient node program are configured to access to the voicemail message recorded at the caller node via the data connection after the voice connection is closed.

In other, more detailed features of the invention, the caller node records the audio signal as a voicemail message. The caller node includes a caller node program having instructions. After the voicemail message is recorded at the caller node, the instructions of the caller node program are configured to contact the recipient node program and to transfer the recorded voicemail message from the caller node to the recipient node. Also, the transfer of the recorded voicemail message from the caller node to the recipient node can involve the use of TCP/IP.

In other, more detailed features of the invention, the instructions of the recipient node program are configured to analyze the voicemail message in real-time and to inform the caller and/or the recipient if a problem is identified during the recording of the audio signal as a voicemail message. The voicemail system can further include a server that is coupled between the caller node and the recipient node. The server includes a server program having instructions configured to analyze the audio signal, detect a defect in the audio signal, enhance the audio signal, and/or restore the audio signal.

An exemplary method according to the invention is a method for analyzing an audio signal from a caller that is stored as a voicemail message for a recipient. The method includes providing the audio signal, analyzing the audio signal, and detecting a defect in the audio signal.

In other, more detailed features of the invention, the method further includes determining whether a portion of the voicemail message is unintelligible based on the analysis of the audio signal, and notifying the caller and/or the recipient when the portion of the voicemail message is determined to be unintelligible. Also, the method can include determining if information is missing from the voicemail message as a result of the defect, and restoring the missing information to the voicemail message in the form of a corrected message. In addition, the method can include determining a confidence level regarding the accuracy of the corrected message, and issuing a warning to the caller and/or the recipient when the confidence level is less than a selectable threshold value. Furthermore the method can include forwarding the corrected message to the caller and/or the recipient.

Another exemplary embodiment of the invention is a computer-readable medium including a program having instructions for processing an audio signal from a caller that is included in a voicemail message for a recipient. The instructions are configured to analyze the audio signal and to detect a defect in the audio signal.

Other features of the invention should become apparent from the following description of the preferred embodiments taken in conjunction with the accompanying drawings, which illustrate, by way of example, the principles of the invention.

### BRIEF DESCRIPTION OF THE DRAWINGS

FIG. 1 is a block diagram of a voicemail messaging system according to a preferred embodiment.

FIG. 2 is a flow diagram of an exemplary algorithm that represents steps taken by the voicemail messaging system of FIG. 1.

FIG. 3 is a block diagram of a voicemail messaging system according to another preferred embodiment.

### DETAILED DESCRIPTION OF THE PREFERRED EMBODIMENTS

Embodiments of the present invention provide for the detection of noise, dropouts, or related distortions in the audio signal of a recorded telephone voicemail message. Embodiments of the present invention also provide the caller and/or the recipient with notification when a portion of the recorded voicemail message, i.e., a part of the voicemail message and/or the entire voicemail message, is unintelligible, e.g., the voicemail message's audio signal includes excessive noise and/or dropouts. In addition, embodiments of the present invention provide for the addition of speech enhancements to an audio signal included in a voicemail message. Embodiments also provide for the restoration of an audio signal included in a voicemail message. Embodiments of the present invention also assign a confidence level to the accuracy of each restored audio signal. Embodiments of the present invention also provide the ability to increase the quality of the recorded audio signal by filtering out noise.

Recipient Node (“RN”)-Oriented Embodiment

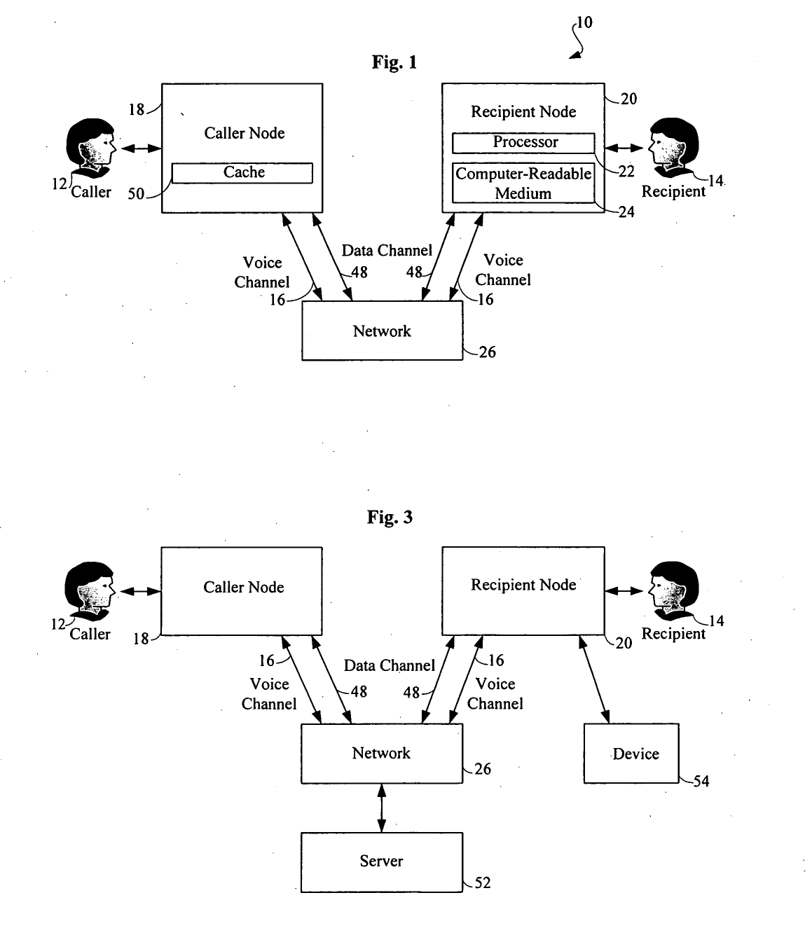

FIG. 1 is a block diagram of a voicemail system 10 according to an embodiment of the present invention. In particular, the embodiment illustrated in FIG. 1 is a recipient node (“RN”)-oriented embodiment in which a caller 12 calls a recipient 14, which establishes a voice connection, via a voice channel 16, between a caller node (“CN”) 18, e.g., a phone, most likely a cell phone, and an RN 20, e.g., a voice mail server. The RN contains a general-purpose processor 22 that executes a software program to perform described functions. The program is stored in a computer-readable medium 24, e.g., a RAM, a ROM, an EEPROM, a flash memory, a CDROM, a DVD, an optical disk, a magnetic cassette, a magnetic disk drive, or any other medium that can be used to store information, that is included in the RN.

The RN 20 and CN 18 are coupled together using a network 26, for example, a circuit-switched network. Example circuit-switched networks include telephone networks and pack-switched networks, e.g., the Internet. The caller 12 is prompted to leave a voicemail message, which is recorded at the RN. The RN program, which runs on the processor 22 included in the RN, or on another processor (not shown) that is coupled to the RN, analyzes the recorded voicemail message to detect defects, e.g., noise and dropouts. If the recorded voicemail message fails to meet a predetermined minimal quality level, the program contacts the caller and/or the recipient 14, e.g., via electronic-mail or via telephone using synthetic speech or pre-recorded messages, and informs the caller and/or the recipient of the nature and severity of the defects, e.g., too much distortion noise, too much background noise, and/or too many dropouts.

The program can inform the caller 12 and/or the recipient 14 of the steps being taken to rectify the dropouts in the audio signal of the recorded voicemail message. For example, the program can inform the caller and/or the recipient that speech enhancement is being used to correct dropouts in the recorded voicemail message. Also, the program can notify the caller and/or the recipient of a confidence level, e.g., expressed as a percentage, associated with a restoration process of the recorded voicemail message.

A method according to the present invention for restoring a recorded voicemail message involves converting the speech audio signal into a text transcript using automated digital dictation/transcription technology, e.g., DRAGON NATURALLYSPEAKING from ScanSoft of Peabody, Mass. After the speech audio signal is converted into a text transcript, automated linguistic analysis performed by the program is applied to the text of the transcript to intelligently decipher the information lost during audio signal dropouts. For example, at the least, phonemes, e.g., syllables or component word sound units, words, and/or phrases that precede or follow identified distortion, dropout, or otherwise lost message components could be compared to databases of the same or similar preceding or following phonemes, words, or phrases to see if a match is found. If so, then, a determination of the strength, i.e., probability or confidence level, of the match could be made. An example rule of thumb for matching could be that the shorter the gap, and the frequency with which the gap-filling phoneme or words appears between the preceding and following word(s), the higher the confidence level. During this process, both static databases, e.g., tables, of words and phrases already on file could be consulted, as well as relational databases that generate phrases given grammar rules. Thus, if sufficient information is available in the text of the transcript, linguistic analysis can be used to determine and restore the lost information.

The automated linguistic analysis can exploit patterns and information intrinsic to a voice/text message to fill in audio signals that are lost during dropouts. Such patterns and information can include, for example, the length of the dropouts, the caller's rate of speaking, i.e., words per second, and the repetition of certain phrases. The automated linguistic analysis also can draw from external information, e.g., common phrases, common sentence constructions, and linguistic co-occurrence sets, i.e., Boolean linguistic analysis (see http://library.albany.edu/internet/boolean.html), to fill in audio signals that are lost during dropouts.

The restored results can be in the form of a corrected text message or a corrected audio message that can be forwarded to the recipient 14 and/or the caller 12. Also, the restored results can include the original audio signal with text-to-speech fragments, i.e., audio signals, based on the restored text results, that are inserted into the original audio signal. Additionally, the restored results can be an entirely synthetic text-to-speech version of the restored text. The present invention allows the voicemail sender and/or the recipient of the voicemail message to elect the automated linguistic analysis and restoration service.

The confidence level can be assigned, for example, according to the above-discussed rule of thumb for matching, where the shorter the gap and the frequency with which the gap-filling phoneme or words appears between the preceding and following word(s), the higher the confidence level. Also, the confidence level can be assigned, for example, using the same system that detects distortions or gaps in post-processed messages to see how much, if any, of the distortion or gap remains.

In addition, the program can recommend follow-up procedures, e.g., a message sent to the caller 12 and/or the recipient 14 that the voicemail message is irrecoverable, and for the caller to please call the recipient again. These steps can occur after attempts have been made to enhance/restore the audio speech signal. A user, e.g., the caller or the recipient, can set confidence levels, e.g., a selectable threshold value, below which a warning, e.g., explicit notification of the restoration confidence level, will be issued, or below which users do not want voicemail messages to be recorded. The program then can attempt to enhance the audio signal and/or restore segments of the audio signal subject to more severe defects, including complete dropouts.

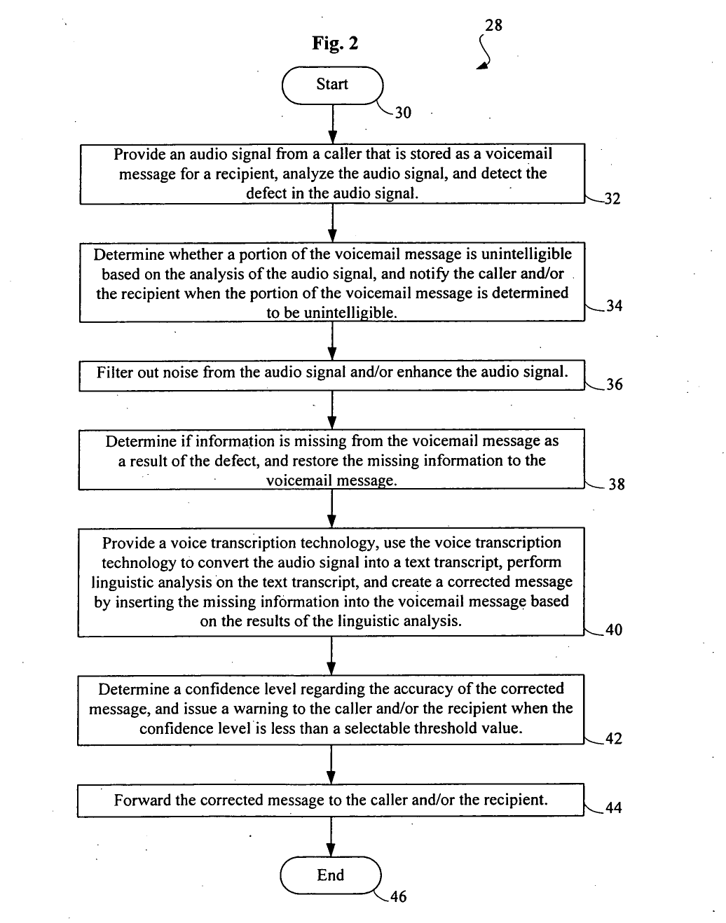

An exemplary algorithm 28 that represents the steps taken by the program is illustrated in FIG. 2. This algorithm can be implemented in computer-readable instructions that are stored in a computer-readable medium 24. After the start 30 of the algorithm, in the next step 32, the program is provided the audio signal that is stored as a voicemail message for the recipient 14 from the caller 12. The program analyzes the audio signal and detects a defect in the audio signal. Next, in step 34, the program determines whether a portion of the voicemail message is unintelligible based on the analysis of the audio signal, and notifies the caller and/or the recipient when the voicemail message is determined to be unintelligible. In step 36, the program filters out noise from the audio signal and/or enhances the audio signal.

Next, in step 38, the program 10 determines if information is missing from the voicemail message as a result of the defect. If so, the missing information is restored. In step 40, the program is provided a voice transcription technology, which is used to convert the audio signal into a text transcript. Linguistic analysis is performed on the text transcript, and a corrected message is created by inserting the missing information into the voicemail message based on the results of the linguistic analysis. In step 42, the program determines a confidence level regarding the accuracy of the corrected message, and issues a warning to the caller 12 and/or the recipient 14 when the confidence level is less than a selectable threshold value. Next, at step 44, the program forwards the corrected message to the caller and/or the recipient. The algorithm ends at step 46.

CN Cache and RN/CN Follow-Up Embodiment

In another embodiment, the caller 12 calls the recipient 14 and, in doing so, establishes a voice connection, via the voice channel 16, between the CN 18 and RN 20. The program executing in the RN prompts the caller to leave a voicemail message, which is recorded at both the RN and the CN. The program then proceeds, as discussed above in the RN-oriented embodiment, to (1) detect defects in the recorded voicemail message, (2) inform the caller and/or the recipient of defects in the recorded voicemail message, (3) attempt speech enhancement on the defects, and (4) attempt speech restoration.

However, in this embodiment, the program executing in the RN 20 can communicate with software in the CN 18 in an automated fashion after the voice connection is closed. A data connection between the RN and CN is maintained after the voice connection is closed via a parallel data channel 48. The program executing in the RN is permitted to have access to a possibly cleaner and superior voice recording stored in cache 50 in the CN for use in speech enhancement and restoration efforts. A message restoration confidence level can be associated with each message and communicated to the caller 12 and/or the recipient 14.

CN Cache Only Embodiment

In another embodiment, the voicemail message is recorded in the CN 18, not at the RN 20. After the voicemail message is recorded, a program executing in the CN calls the program executing in the RN (establishing a data connection), and the program executing in the CN digitally transfers the recorded voicemail message from the CN to the RN, using integrity-checking transport protocols, e.g., TCP/IP, to minimize dropouts.

Real-Time Embodiment

In another embodiment, the caller 12 calls the recipient 14, and establishes a voice connection between the CN 18 and the RN 20. Unlike the RN-oriented embodiment, the program executing in the RN does not wait to analyze the voicemail message until the recording of the voicemail message is complete. Instead, the program analyzes the voicemail message in real-time, and reports back to the caller and/or the recipient any identified problems during the recording of the voicemail message. Example messages that can be sent to the caller and/or the recipient include the following: “too much background noise,” “please speak louder,” “please repeat the last 5 seconds of your voice message,” or “your message may only be received intact with a certain percentage confidence level due to noise, dropouts, or distortion.” Additionally, given real-time linguistic analysis of gaps, and if such gaps have been identified, and the analysis suggests “x” or “y” as proper fill-in material, the caller could be asked whether identified missing information should be “x” or “y”.

Mediator Server Embodiment

In another embodiment shown in the block diagram of FIG. 3, a mediator server 52 is coupled between the caller node 18 and the recipient node 20. The mediator server is a computer system, e.g., a general-purpose computer system running the specialized audio processing software, possibly in addition to other applications. The mediator server runs the software that normally would be run at the RN in the RN-oriented embodiment. One advantage of using a mediator server is that the mediator server can have access to greater processing/storage capability than a typical RN, allowing for more powerful and faster voicemail integrity services. The detection, notification, enhancement, and/or restoration features can be offered alone or in conjunction with other services available to a caller 12 and/or a recipient 14.

In another embodiment, the caller 12 calls the recipient 14 and establishes a voice connection between the CN 18 and the RN 20 as in the RN-oriented embodiment discussed above. However, the RN connects to a separate device 54, e.g., a mediator server or another server to access detection, notification, enhancement, and restoration service software.

Advantageously, the above embodiments provide a caller 12 and/or a recipient 14 with notification when a portion of a recorded voicemail message is unintelligible. The above embodiments provide for the filtering of noise from a voicemail message, thus, increasing the quality of recorded voicemail messages. Also, embodiments of the present invention allow for the addition of speech and text enhancements to the audio signal included in a recorded voicemail message. In addition, embodiments allow for the restoration of speech and/or text through linguistic analysis.

Embodiments of the present invention are useful in any voicemail system 10 where a telephone call's voice signal is compromised or broken off, and the recipient 14 and/or the caller 12 would like to reconstruct as much as possible of the call while it lasted. Some compelling applications of the present invention include life or death situations, such as 911 service, fire/police/medical response service, and military situations, where fast and clear communications are imperative.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention. Accordingly, the scope of the invention is defined only by the following claims.

What is claimed is:

1. A voicemail system comprising:
a. a caller node configured to facilitate telephonic communication by a caller and to generate an audio signal based on input from the caller; and
b. a recipient node coupled to the caller node and configured to facilitate telephonic communication by a recipient, to receive the audio signal from the caller node, and to record the audio signal as a voicemail message;
c. wherein:
i. the recipient node includes a computer-readable medium having a recipient node program, and
ii. the recipient node program includes instructions that are configured to analyze the audio signal and to detect a defect in the audio signal.

2. The voicemail system according to claim 1, wherein the defect is selected from the group consisting of a dropout, a distortion, and noise.

3. The voicemail system according to claim 1, wherein the caller node or the recipient node are selected from the group consisting of a phone, a computer, and a voicemail server.

4. The voicemail system according to claim 1, wherein:
a. the instructions of the recipient node program detect a defect in the audio signal and inform a user selected from the group consisting of the caller and the recipient of the defect in the audio signal if the audio signal fails to meet a predetermined minimum quality level based on an analysis performed by the instructions of the recipient node program; and
b. the recipient node informs the user of the defect in the audio signal using a method selected from the group consisting of sending the user an electronic-mail message, calling the user using synthesized speech, and calling the user using a prerecorded message.

5. The voicemail system according to claim 1, wherein the instructions of the recipient node program are configured to perform a function selected from the group consisting of:
a. filtering out noise in the audio signal;
b. enhancing the audio signal; and
c. restoring the audio signal.

6. The voicemail system according to claim 1, wherein the instructions of the recipient node program detect a defect in the audio signal and inform a user selected from the group consisting of the caller and the recipient of an item selected from the group consisting of steps being taken to correct the defect in the audio signal, a confidence level associated with a restoration process of the audio signal, and whether the audio signal is recoverable.

7. The voicemail system according to claim 1, wherein the instructions of the recipient node are configured to determine if information is missing from the voicemail message as a result of the defect and to restore the missing information to the voicemail message.

8. The voicemail system according to claim 7, wherein:
a. the recipient node includes a voice transcription technology that is configured to convert the audio signal into a text transcript;
b. the instructions of the recipient node program are configured to perform a linguistic analysis on the text transcript; and
c. the instructions of the recipient node program are configured to create a corrected message by inserting the missing information into the voicemail message based on the results of the linguistic analysis.

9. The voicemail system according to claim 8, wherein the corrected message is selected from the group consisting of a text message, a voicemail message that includes the original audio signal and an additional audio signal that was created based on the results of the linguistic analysis, and a voicemail message that includes a single audio signal created entirely from the results of the linguistic analysis.

10. The voicemail system according to claim 1, further comprising a network that is coupled between the caller node and the recipient node.

11. The voicemail system according to claim 1, further comprising a voice channel that is coupled between the caller node and the recipient node, wherein the voice channel is configured to establish a voice connection between the caller node and the recipient node, and to permit the transfer of the audio signal from the caller-node to the recipient node.

12. The voicemail system according to claim 11, further comprising a data channel that is coupled between the caller node and the recipient node and configured to establish a data connection between the caller node and the recipient node, wherein:
a. the caller node is configured to record the audio signal as a voicemail message;
b. the audio signal is recorded as a voicemail message in the recipient node and the caller node while the voice connection is open;
c. the data connection between the recipient node and the caller node is maintained after the voice connection is closed; and
d. the instructions of the recipient node program are configured to access to the voicemail message recorded at the caller node via the data connection after the voice connection is closed.

13. The voicemail system according to claim 1, wherein:
a. the caller node records the audio signal as a voicemail message;
b. the caller node includes a caller node program having instructions; and
c. after the voicemail message is recorded at the caller node, the instructions of the caller node program are configured to contact the recipient node program and to transfer the recorded voicemail message from the caller node to the recipient node.

14. The voicemail system according to claim 14, wherein the transfer of the recorded voicemail message from the caller node to the recipient node involves the use of TCP/IP.

15. The voicemail system according to claim 1, wherein the instructions of the recipient node program are configured to analyze the voicemail message in real-time and to inform a user selected from the group consisting of the caller and the recipient if a problem is identified during the recording of the audio signal as a voicemail message.

16. The voicemail system according to claim 1, further comprising a server that is coupled between the caller node and the recipient node, wherein the server includes a server program having instructions configured to perform a function selected from the group consisting of analyzing the audio signal, detecting a defect in the audio signal, enhancing the audio signal, and restoring the audio signal.

17. A method for analyzing an audio signal from a caller that is stored as a voicemail message for a recipient, the method comprising:
a. providing the audio signal;
b. analyzing the audio signal; and
c. detecting a defect in the audio signal.

18. The method according to claim 17, wherein the defect is selected from the group consisting of a dropout, a distortion, and noise.

19. The method according to claim 17, further comprising:
a. determining whether a portion of the voicemail message is unintelligible based on the analysis of the audio signal; and
b. notifying a user selected from the group consisting of the caller and the recipient when the portion of the voicemail message is determined to be unintelligible.

20. The method according to claim 17, further comprising performing a function selected from the group consisting of filtering out noise in the audio signal, and enhancing the audio signal.

21. The method according to claim 17, further comprising:
a. determining if information is missing from the voicemail message as a result of the defect; and
b. restoring the missing information to the voicemail message.

22. The method according to claim 21, wherein the step of restoring the missing information to the voicemail message includes:
a. providing a voice transcription technology;
b. using the voice transcription technology to convert the audio signal into a text transcript;
c. performing linguistic analysis on the text transcript; and
d. creating a corrected message by inserting the missing information into the voicemail message based on the results of the linguistic analysis.

23. The method according to claim 22, further comprising:
a. determining a confidence level regarding the accuracy of the corrected message; and
b. issuing a warning to a user selected from the group consisting of the caller and the recipient when the confidence level is less than a selectable threshold value.

24. The method according to claim 22, further comprising forwarding the corrected message to a user selected from the group consisting of the caller and the recipient.

25. A computer-readable medium including a program comprising instructions for processing an audio signal from a caller that is included in a voicemail message for a recipient, wherein the instructions are configured to perform the following steps:
a. analyze the audio signal; and
b. detect a defect in the audio signal.

26. The computer-readable medium according to claim 25, wherein the instructions are configured to perform the following additional steps:
a. determine whether a portion of the voicemail message is unintelligible based on the analysis of the audio signal; and
b. notify a user selected from the group consisting of the caller and the recipient when the portion of the voicemail message is unintelligible.

27. The computer-readable medium according to claim 25, wherein the instructions are configured to perform as a step selected from the group consisting of:
a. filter out noise in the audio signal;
b. add speech enhancements to the audio signal; and
c. determine if information is missing from the voicemail message as a result of the defect and restore the missing information to the voicemail message.

28. The computer-readable medium according to claim 25, wherein:
a. the instructions are configured to facilitate the communication of the voicemail message to a voice transcription technology that is configured to convert the voicemail message into a text transcript;
b. the instructions are configured to perform a linguistic analysis on the text transcript in a search for information that is missing from the text transcript; and
c. the instructions are configured to create a corrected message within which the information that is missing from the text transcript is restored based on the linguistic analysis.

29. The computer-readable medium according to claim 28, wherein the instructions are configured to determine a confidence level regarding the accuracy of the corrected message and to prompt a warning for issuance to a user selected from the group consisting of the caller and the recipient when the confidence level is less than a selectable threshold value.
